(19) United States
(12) Patent Application Publication
(10) Pub. No.: US 2008/0282834 A1
(43) Pub. Date: Nov. 20, 2008

(54) Bowden Cable Actuation System

(75) Inventor: Uwe Schmale, Huckeswagen (DE)

Correspondence Address: FOLEY AND LARDNER LLP;SUITE 500, 3000 K STREET NW, WASHINGTON, DC, 20007, US

(73) Assignee: Johnson Controls GmbH

(21) Appl. No.: 11/664,578

(22) PCT Filed: Oct. 5, 2005
(86) PCT No.: PCT/EP05/55020

§ 371 Date: Jan. 7, 2008

(30) Foreign Application Priority Data
Oct. 5, 2004 (DE) 10 2004 048 737.5
Jun. 10, 2005 (DE) 10 2005 027 052.2

(51) Int. Cl. F16C 1/22

(52) U.S. Cl. 74/502.6

(57) ABSTRACT

A Bowden cable actuation system and/or a seat adjuster can be produced simply and cost-effectively. The seat adjuster includes a compensation means that reduces damage to the Bowden cable, actuation system and/or seat adjuster when the Bowden cable is subjected to a tensile force beyond a predetermined point.

### CROSS-REFERENCE TO RELATED PATENT APPLICATIONS

The present Application is a National Stage of Application PCT/EP2005/055020 entitled “Bowden Cable Actuation System” filed Oct. 5, 2005 and published as PCT Publication No. WO 2006/037791 A1 on Apr. 13, 2006, which claims priority to German Patent Application Nos. DE 10 2004 048 737.5 filed Oct, 5, 2004 and DE 10 2005 027 052.2 filed Jun. 10, 2006, the disclosures of all aforementioned documents being incorporated herein by reference in their entireties.

### BACKGROUND

The present disclosure generally relates to a Bowden cable actuation system. In one exemplary embodiment, the Bowden cable has a sheath and an inner cable on which a means is fixedly arranged; upon movement of the Bowden cable, the means interacts with a mechanism that has at least one lever that can be actuated by the means; in this exemplary embodiment, an end stop limits the movement of the inner cable in the tensioning direction, and a compensation means is elastically deformable when a tensile force is applied to the inner cable beyond the end stop. Furthermore, the present disclosure relates to a seat adjuster of a motor vehicle that has a rail unlocking system and a memory function, wherein the rail unlocking system can be actuated by a movably mounted movement means and the memory function can be triggered by a movably mounted triggering means, and the actuating means and the triggering means can be driven by an activation system.

Bowden cables are often used, for example, in automobile manufacturing in order to adjust an adjustable device, such as, for example, flaps or unlocking/locking mechanisms. The Bowden cables often carry out more than just one function. Since it is comparatively expensive and therefore undesirable to very exactly set the tensioning path of Bowden cables, in particular because they are often actuated manually, it is important that the Bowden cable, if loaded further beyond a certain predefined limit, does not damage the sheath which surrounds the inner cable.

Conventional seat adjusters are described, for example, in German utility model DE 202 10 895 U1 and laid-open German specification DE 103 10 016 A1. In both of these documents, a motor vehicle with a seat frame is described. The seat frame has a backrest which is mounted pivotably on the seat frame and can be folded forward in the direction of the seat surface of the seat frame. The seat has a longitudinal guide with which the seat frame can be moved in order to set the longitudinal position in the sitting direction. The seat frame is locked in a previously set seat longitudinal position by means of a fixing device. A coupling mechanism that acts on the fixing device unlocks this fixing device when the backrest is folded forward in the direction of the seat surface. A memory device can be used to return the seat frame into a seat longitudinal setting, which is defined as the memory position, during a movement in the longitudinal direction of the rail. The fixing device and the memory device are activated by a Bowden cable which is connected to the backrest. Since these Bowden cables always have tolerances, tension from the Bowden cable beyond the unlocking or memory position is frequently exerted on the activating elements. This phenomenon is referred to in automotive engineering as an “excessive travel”. The excessive travel frequently leads to premature failure of the unlocking device or of the memory device or to damage to the Bowden cable.

Therefore, it is desirable to provide a Bowden cable actuation system and/or a seat adjuster which can be produced simply and cost-effectively and in which damage to the Bowden cable, the actuation system and/or the seat adjuster is avoided if the Bowden cable is subjected to a tensile force beyond a certain limit avoided.

### SUMMARY

One exemplary embodiment relates to a Bowden cable actuation system that includes a Bowden cable having a sheath and an inner cable configured to interact with a first mechanism and second mechanism; an end stop that limits the movement of the inner cable in a tensioning direction; and a compensation means that is elastically deformable when a tensile force is applied to the inner cable beyond the end stop.

Another exemplary embodiment relates to a seat adjuster for a motor vehicle seat that includes a rail unlocking system. The rail unlocking system can be actuated by a movably mounted actuating means. A memory function can be triggered by a movably mounted triggering means. The actuating means and the triggering means can be driven by an activation system that can be actuated with a Bowden cable actuation system.

Another exemplary embodiment relates to a Bowden cable actuation system that includes a Bowden cable having a sheath and an inner cable configured to interact with a first mechanism and second mechanism; an end stop that limits movement of the inner cable, and a spring deformable when a predetermined tensile force is applied to the inner cable.

Another exemplary embodiment relates to a seat adjuster for a motor vehicle seat that includes a selectively lockable rail system. The rail system is configured to be actuated by an actuator. A spiral spring is configured to be triggered by a movable trigger. The actuator and the trigger can be driven by an activation system which includes a Bowden cable actuation system.

### BRIEF DESCRIPTION OF THE DRAWINGS

The inventions are explained below with reference to FIGS. 1a to 6. These explanations are merely by way of example and do not restrict the invention. The explanations apply equally to all of the subject matters of the invention.

FIG. 1a shows a Bowden cable actuation system according to an exemplary embodiment, in which the Bowden cable is not actuated,

FIG. 1b shows the Bowden cable actuation system of FIG. 1a, in which a lever for an easy-entry mechanism is actuated, and

FIG. 1c shows the Bowden cable actuation system of FIGS. 1a and 1b, in which the displacement of the entire Bowden cable is actuated.

FIG. 2 shows a seat adjuster according to an exemplary embodiment in the design position,

FIG. 3 shows the seat adjuster according to an exemplary embodiment with activated memory function,

FIG. 4 shows the seat adjuster according to an exemplary embodiment with activated memory function and released rail locking system,

FIG. 5 shows the seat adjuster according to an exemplary embodiment when there is excessive travel, and

FIG. 6 shows the activation system during excessive travel.

### DETAILED DESCRIPTION

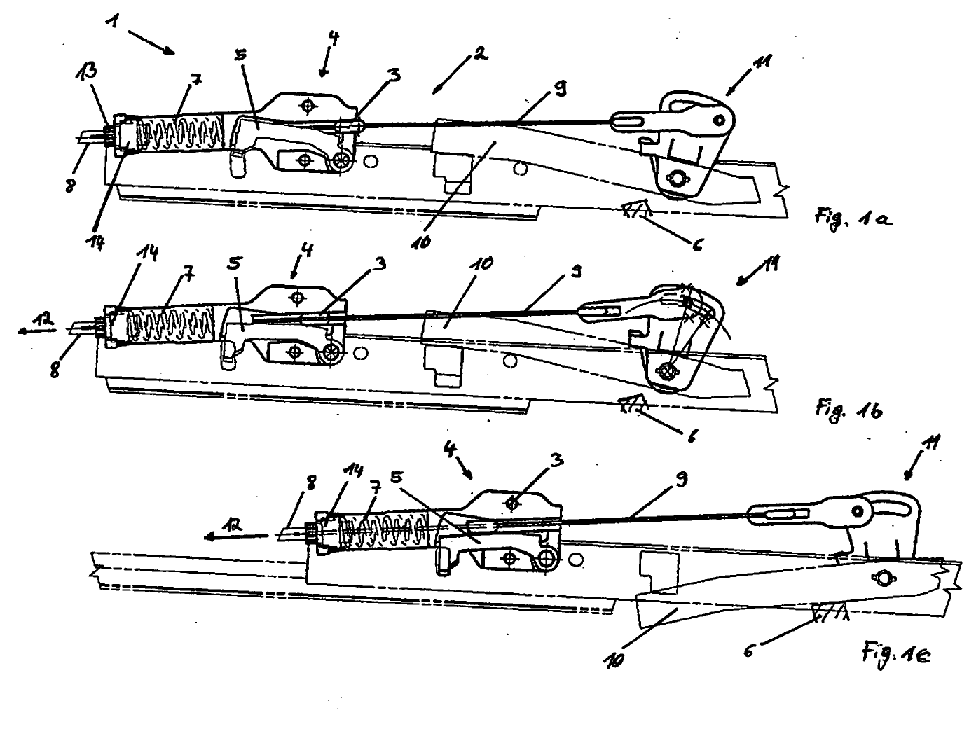

FIG. 1a shows the Bowden cable actuation system 1 according to exemplary embodiment with two adjusting mechanisms 4, 11. The Bowden cable 2 comprises a sheath 8 and an inner cable 9. A sliding block 3 is arranged fixedly on the inner cable 9 and, as soon as the inner cable 9 is pulled in the tensioning direction indicated by arrow 12, the sliding block 3 presses the lever 5 downward. At its right end, the Bowden cable 9 is arranged in a sliding manner on the adjusting mechanism 11.

FIG. 1b shows the Bowden cable actuation system according to FIG. 1a, wherein the sliding block 3 has already been pulled a distance to the left and, in the process, has pressed the lever 5 downward by a certain distance. As a result, the lever 5 actuates the easy-entry mechanism, in particular the memory function, by means of which it is ensured that the car seat, in particular the seat rail, is folded back into the same position after being folded forward or pushed forward (as shown in FIG. 1c). Since the right end of the inner cable is mounted in a sliding manner in the adjusting mechanism 11, the lever 10 of the adjusting mechanism 11 remains unactuated for the time being.

FIG. 1c shows the Bowden cable actuation system, in which the displacement of the entire Bowden cable is actuated. The sliding block 3 has been slid somewhat further to the left and has pressed the lever 5 further downward. This change in the position of the lever 5 does not activate any further function. The comparatively long sliding displacement of the sliding block 3 makes it possible to set the time at which the easy-entry mechanism is actuated, in particular also relative to the actuation of the further adjusting mechanism 11. Furthermore, the inner cable 9 has pivoted the lever 10 downward counterclockwise until it is in engagement with the end stop 6. The seat rail is unlocked by the pivoting of the lever 10 and can be displaced to the right, as illustrated in FIG. 1c. After the lever 10 is in engagement with the end stop 6, the inner cable 9 cannot move further. If a further tensile force is exerted on the inner cable in the direction of arrow 12, the sheath 8 presses onto the sliding mounting 14 of the spring 7 and compresses the latter, and therefore the sheath is not damaged.

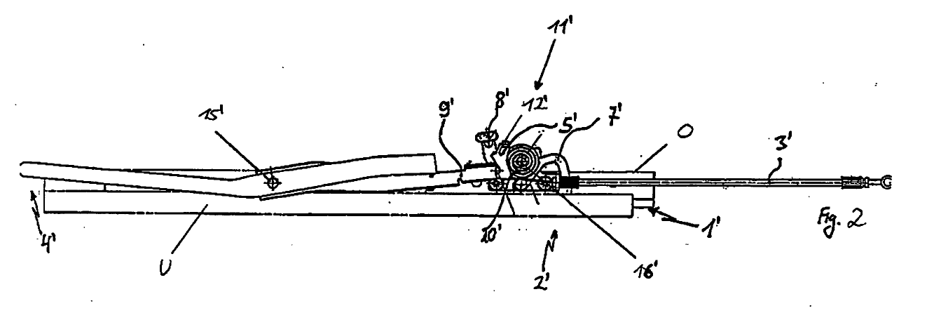

FIG. 2 shows a seat adjuster 1′ according to an exemplary embodiment that has an upper rail O and a lower rail U. The lower rail U is connected fixedly to the vehicle body. The upper rail O is arranged displaceably on the lower rail and can be fixed in a quite specific position on the lower rail by the rail locking system. The rail unlocking or locking system 4′ is activated by the actuating lever 9′ which is mounted rotatably about the rotary joint 15′. Furthermore, the seat adjuster has a memory function 2′ which has the effect that the seat can be automatically returned into a quite specific position after it has been brought into an easy-entry position. This memory function is actuated by the triggering lever 7′. Both the actuating lever 9′ and the triggering lever 7′ are driven by the activation system 11′, which essentially has an activating means 8, a connecting means 5′ and a spiral spring 10′. Both the activating means 8′ and the connecting means 5′ are mounted rotatably about the axis 16′ and are connected to each other by means of the spiral spring 10′, wherein one end of the spiral spring interacts with the connecting means 5′ and one end interacts with the activating means 8′. Spiral spring 10′ causes the activating means 8′ and the connecting means 5′ to be connected to each other in an angle-changeable (or pivotable) manner. The spiral spring is pre-stressed such that it presses the connecting means 5′ against the stop 12′ which is arranged on the activating means 8′. The Bowden cable 3′ is connected to the connecting means 5′. FIG. 2 illustrates the “design position” or operating position. In this position, the upper rail and the lower rail are locked to each other and the memory function is deactivated.

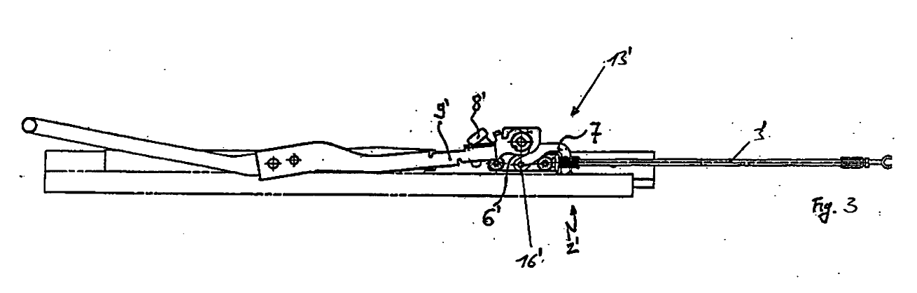

FIG. 3 shows the state in which the memory function is activated. For the sake of simplicity, the spiral spring 10′ and the connecting piece 5′ are omitted in this illustration. By folding over the backrest of the motor vehicle seat, a tensile force is exerted on the Bowden cable 3′ and is transmitted to the connecting means 5′. The tensile force is transmitted by the spiral spring 10′ to the activating means 8′ where it induces a torque which causes the activating means 8′ to rotate counterclockwise. The activating means 8′ has a cam contact surface 6′ which interacts with the triggering means 7′ and triggers the memory function by it pressing the triggering lever 7′ downward into the actuating setting and keeping it in this setting. Since the spring force of the spiral spring 10′ is greater than the force which is required in order to press the triggering means 7′ downward, the relative position between the connecting means and the activating means does not change when the memory function is triggered. In this setting, the activating means also already bears against the actuating lever 9′ without moving the latter.

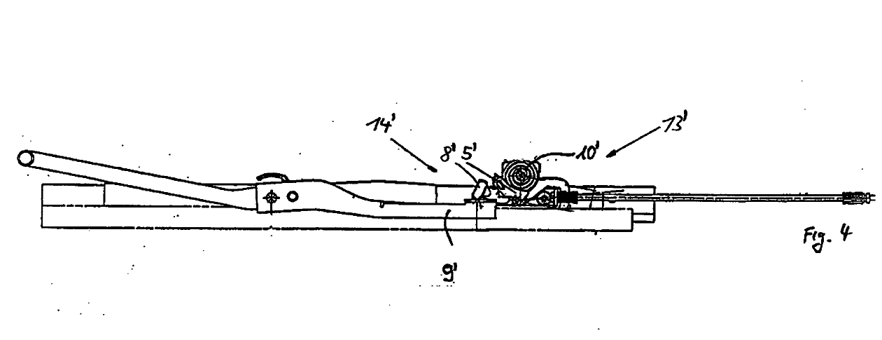

FIG. 4 shows the unlocking of the rail locking system 4′. By further pulling of the Bowden cable, i.e., further folding of the backrest of the motor vehicle seat in the direction of the seat surface, the activating means 8′ is rotated further counterclockwise and presses the actuating lever 9′, which is connected to the rail unlocking system 4′, downward into the actuating position 14′ and therefore unlocks the upper rail and the lower rail such that the upper rail can be displaced forward in a freely movable manner into the easy-entry position. Also in this setting of the activating means 8′, the triggering lever 7′ is kept in the actuating setting 13′. Since the spring force of the spiral spring 10′ is greater than the force which is required in order to displace the actuating lever 9′ into the actuating position and to keep it there and in order to keep the triggering means 7′ in the actuating setting 13′, the relative position between the connecting means and the activating means does not change when the unlocking function is triggered.

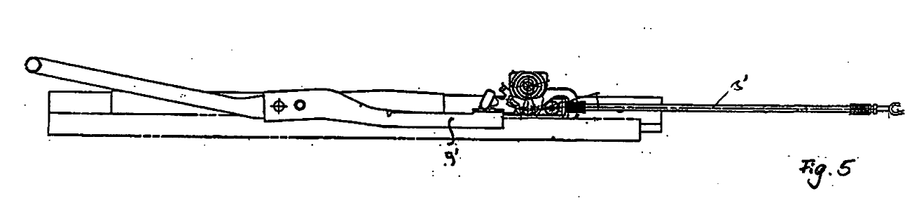

FIG. 5 shows the “excessive travel” situation. If the rear seat is now pressed even further in the direction of the seat surface, a further tension is exerted on the Bowden cable although both the actuating lever 9′ and the triggering means 7′ are already in their end positions. In this situation, the tensile force of the Bowden cable 3′ is becoming greater than the spring force of the spiral spring 10′ and therefore the connecting means 5′ is moved away counterclockwise from the stop 12′. However, a change in the position of the activating means 8′ does not take place, and therefore high forces are not unnecessarily exerted on the actuating lever 9′ or the triggering means 7′.

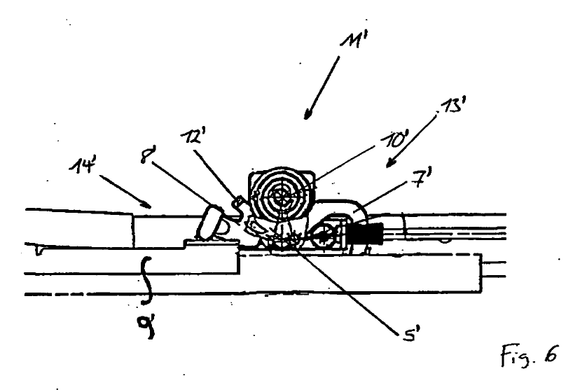

FIG. 6 shows an enlarged illustration of the activation system according to FIG. 5. During excessive travel, the connecting means 9′ moves away from the stop 12′, which is arranged on the activating means 8′, and therefore compensates for the excessive travel.

As soon as the backrest is moved away again from the seat surface, the connecting means 5′ is first of all moved in the clockwise direction toward the stop 12′. The activating means 8′ is then moved back in the clockwise direction into the design position.

The Bowden cable actuation system according an exemplary embodiment can be produced simply and cost-effectively. The compensation means avoids damage occurring to the sheath and/or the mechanisms actuated by the Bowden cable when the inner cable is loaded beyond a certain limit. The Bowden cable actuation system according to the invention can actuate a plurality of means, for example levers, simultaneously or successively.

The Bowden cable has a means, for example a sliding block, which interacts with a mechanism which has at least one lever which can be actuated by the means. In an exemplary embodiment, however, the Bowden cable actuation system has a further mechanism which is in engagement, for example, with the end of the Bowden cable. This mechanism preferably has at least one further lever with which a further function, for example unlocking or locking, can be undertaken. This further lever also interacts with an end stop which prevents a further movement of the Bowden cable in the tensioning direction.

The Bowden cable actuation system may be part of any desired mechanism, for example, part of a motor vehicle, and in particular part of a vehicle seat. The Bowden cable actuation system can be part of the easy-entry mechanism of a car seat, with which entry to the seat rows behind the driver's seat or passenger's seat is facilitated.

According to an exemplary embodiment, the position of the activating means is no longer changed during excessive travel, and therefore excessive forces do not act on the rail unlocking system or the memory function. The seat adjuster can be produced and fitted simply and cost-effectively, since substantially greater tolerances in the setting of the Bowden cable are possible than was hitherto the case.

The seat adjuster according to an exemplary embodiment has a rail unlocking system. This rail unlocking system has the effect that the lower rail and the upper rail, which are mounted displaceably relative to each other, can be locked or unlocked in order to be able to transfer the motor vehicle seat in the longitudinal direction into a quite specific position in which the motor vehicle seat is then locked. The words rail unlocking system are used equally for the unlocking and locking operations. However, the rail unlocking system is also required in the “easy-entry function”, in which entry of the passenger or the pushing of an object into the rear of the motor vehicle is to be facilitated by folding the backrest forward. The operation to fold the backrest forward actuates the rail unlocking system such that the upper rail can slide forward freely on the lower rail, which increases the space behind the particular motor vehicle seat for entry purposes.

Furthermore, according to an exemplary embodiment, the seat adjuster has a memory function. Memory functions have the task of making it possible for the vehicle seat, after it has been brought into the easy-entry position, to subsequently be displaced rearward again with the fixing device still unlocked until it is automatically stopped by means of the memory device in a seat position defined as the memory position. By this means, the seat, after being pushed back and stopping in the memory position, is automatically in a seat longitudinal position in which a passenger can sit down on the vehicle seat. The seat is therefore automatically stopped during its rearward movement by means of the memory device in a seat longitudinal position defined as the memory position.

Both the seat unlocking system and the memory function are driven by an activation system which, in turn, is connected to a Bowden cable, the one end of which interacts with the activation system and the other end of which interacts with the backrest of the motor vehicle.

According to an exemplary embodiment, the seat adjustment has the Bowden cable actuation system with reference being made, with regard to the disclosure thereof, to what has been said above.

The activation system can have an activating means. This activating means firstly actuates a triggering means, for example a lever, which actuates the memory function. The activating means preferably has for this a cam contact surface which moves the triggering means and fixes it in certain positions. Furthermore, the activating means is also used to drive an actuating means, for example a lever, which, in turn, actuates the rail unlocking system, i.e., locks the lower rail to the upper rail or unlocks it therefrom. The actuating means is preferably a lever which is mounted rotatably.

According to an exemplary embodiment, the activation system can be actuated by the Bowden cable actuation system.

The activation system can have a connecting means which is connected to the Bowden cable. This connecting means is furthermore connected to the activating means in an angle-changeable manner via a spring element, wherein the force which is required to activate the actuating means or the triggering means is smaller than the spring force of the spring element.

The spring element may be any desired spring element customary to a person skilled in the art. In an exemplary embodiment, the spring element is a spiral spring, one end of which interacts with the activating means and the other end of which interacts with the connecting means. This spring element is preferably pre-stressed in order, for example, to avoid rattling noises in the region of the activation system.

The activation system can have a stop which limits a change in angle between the activating means and the connecting means in one direction of rotation. This embodiment uses a stop in order to keep the spring element under a constant pre-stress.

When the Bowden cable is actuated, the activating means can transfer the triggering means into an actuating setting and keep it there.

Furthermore, when the Bowden cable is actuated, the activating means transfers the actuating means into an actuating position. The actuating setting can be reached before the actuating position.

When there is excessive travel of the Bowden cable, the position of the connecting means with respect to the position of the activating means preferably changes. When there is excessive travel of the Bowden cable, the tensile force of the Bowden cable exceeds the spring force of the spring element.

1-19. (canceled)

20. A Bowden cable actuation system, comprising:
a Bowden cable having a sheath and an inner cable configured to interact with a first mechanism and second mechanism;
an end stop that limits the movement of the inner cable in a tensioning direction, and
a compensation means that is elastically deformable when a tensile force is applied to the inner cable beyond the end stop.

21. The system of claim 20, further comprising:
a sliding means that interacts with the first mechanism when the Bowden cable is actuated and that is arranged fixedly on the inner cable.

22. The system of claim 21, further comprising:
at least one lever configured to be actuated by the sliding means.

23. The system of claim 21 wherein the sliding means is a sliding block.

24. The system of claim 20 wherein the end stop is part of the second mechanism, and the second mechanism includes at least one lever.

25. The system of claim 20 wherein the Bowden cable is slidably mounted relative to the second mechanism.

26. The system of claim 20 wherein the Bowden cable actuation system is part of a motor vehicle.

27. The system of claim 26 wherein the Bowden cable actuation system is part of a seat.

28. The system of claim 27 wherein the Bowden cable actuation system is part of an easy-entry mechanism.

29. A seat adjuster for a motor vehicle seat, comprising:
a rail unlocking system configured to be actuated by a movably mounted actuating means; and
a memory function configured to be triggered by a movably mounted triggering means;
wherein the actuating means and the triggering means are configured to be driven by an activation system that can be actuated with a Bowden cable actuation system.

30. The seat adjuster of claim 29 wherein the activation system has an activating means and a connecting means that are connected to each other in an angle-changeable manner via a spring element, and the force for activating the actuating means and the triggering means is smaller than the spring force of the spring element.

31. The seat adjuster of claim 30 wherein the activating means has a cam contact surface which interacts with triggering means.

32. The seat adjuster of claim 30 wherein, when the Bowden cable is actuated, the activating means transfers the triggering means into a constant actuating setting.

33. The seat adjuster of claim 30 wherein the spring element is pre-stressed.

34. The seat adjuster of claim 30 wherein, when there is excessive travel of the Bowden cable, the tensile force of the Bowden cable exceeds the spring force of the spring element.

35. The seat adjuster of claim 29 wherein the Bowden cable is connected on an end to a connecting means.

36. The seat adjuster of claim 35 wherein the activation system has a stop which limits a change in angle between the activating means and the connecting means in one direction of rotation.

37. The seat adjuster of claim 35 wherein, when there is excessive travel of the Bowden cable, the position of the connecting means with respect to the position of the activating means changes.

38. The seat adjuster of claim 29 wherein, when the Bowden cable is actuated, the activating means transfers the actuating means into an actuating position.

39. The seat adjuster of claim 38, wherein an actuating setting is reached before the actuating position.

40. A Bowden cable actuation system, comprising:
a Bowden cable having a sheath and an inner cable configured to interact with a first mechanism and second mechanism;
an end stop that limits movement of the inner cable in a tensioning direction, and
a spring deformable when a predetermined tensile force is applied to the inner cable.

41. The system of claim 40 wherein the Bowden cable actuation system is part of a motor vehicle seat easy-entry mechanism.

42. A seat adjuster for a motor vehicle seat, comprising:
a selectively lockable rail system configured to be actuated by an actuator; and
a spiral spring configured to be triggered by a movable trigger;
wherein the actuator and the trigger are configured to be driven by an activation system comprising a Bowden cable actuation system.

43. The seat adjuster of claim 42 wherein the activation system has an activator and a connector that are pivotally connected via the spiral spring, and wherein the force for activating the actuator and trigger is smaller than a predetermined force applied by the spiral spring.

44. The seat adjuster of claim 42 wherein the activator has a cam contact surface that interacts with the trigger.

45. The seat adjuster of claim 42 wherein, when the Bowden cable is actuated, the activator activates the trigger.

46. The seat adjuster of claim 45 wherein the activation system comprises a stop which limits the rotation between the activator and the connector with respect to one direction of rotation.

47. The seat adjuster of claim 42 wherein, when the Bowden cable is displaced beyond a predetermined threshold, the position of the connector with respect to the position of the activator changes.

48. The seat adjuster of claim 42 wherein, when the Bowden cable is actuated, the activator activates the actuator.
